(19) United States
(12) Patent Application Publication
(10) Pub. No.: US 2011/0209065 A1
(43) Pub. Date: Aug. 25, 2011

(54) METHOD AND SYSTEM FOR CONSUMER-SPECIFIC COMMUNICATION BASED ON CULTURAL NORMALIZATION TECHNIQUES

(75) Inventors: Eve Del Rio, Bridgewater, NJ (US); Donald P. Reitberg, Bedminster, NJ (US); Juan G. Espinosa, Weehawken, NJ (US); Fernando Hernandez, Issaquah, WA (US)

(73) Assignee: FARMACIA ELECTRONICA, INC., Weehawken, NJ (US)

(21) Appl. No.: 13/033,033

(22) Filed: Feb. 23, 2011

Related U.S. Application Data
(60) Provisional application No. 61/307,200, filed on Feb. 23, 2010.

(51) Int. Cl. G06F 3/01; G06F 15/16

(52) U.S. Cl. 715/733

(57) ABSTRACT

A method and system for providing consumer-specific communication based on cultural-normalization techniques. The method includes obtaining information about the consumer using an interactive interface, receiving an identification of a consumer-selected language and an output format selection, providing plain-language output information in the consumer-selected language and output format, presenting questions, by a query/interrogation unit, regarding the plain-language output information, acquiring responses to the presented questions, and ascertaining an understanding of the plain-language output information based on the acquired responses. The system includes a controller, an interactive interface unit, a format selection unit, a language selection unit providing content in a user-selected language, a query/interrogation unit, and a response evaluation unit analyzing responses to determine a user's literacy level. The response evaluation unit configured to mine, analyze, and/or parse contents of a database containing user responses to the queries.

### CLAIM OF PRIORITY

This application claims the benefit of priority, under 35 U.S.C. §119(e), of U.S. Provisional Application No. 61/307,200, filed Feb. 23, 2010, and titled “Method and Apparatus For Consumer-Specific Communication Based Upon Cultural Normalization,” which is hereby incorporated by reference in its entirety.

### BACKGROUND

There is great interest in facilitating the proper and productive use of medications by all patients and consumers. Early attempts to improve medication use involved call centers that counseled the patient in the patient's native language. At the federal level, the focus in the United States is on overall public health. The Food and Drug Administration (FDA) is undertaking a broad effort to manage and mitigate risk due to inappropriate drug use. The federal mandate is to improve the efficacy and safety of drugs for the entire U.S. population, including all ethnic sub-populations.

The FDA's Safe Use Initiative is a collaborative effort aimed at reducing preventable harm from medications. Through this initiative, the FDA seeks to reduce preventable harm from medications, thereby improving patient health. Under the Safe Use Initiative, the FDA plans to identify, using a transparent and collaborative process, specific candidate cases (e.g., drugs, drug classes, and/or therapeutic situations) that are associated with significant amounts of preventable harm. Cases can be carefully analyzed for their potential for coordinated FDA/stakeholder actions. Through a coordinated effort, involving all interested stakeholders, the FDA hopes to minimize the risks associated with using medications and reduce preventable harm.

In at least one state, pharmacy regulators have required that pharmacies provide prescription drug data in many languages in a manner suitable for multiple ethnicities. Other state pharmacy boards may also bolster requirements to ensure that pharmacies provide adequate counseling to minority patients.

Although drugs, devices and other medical products are comprehensively studied in a controlled clinical setting for purposes of receiving marketing authorization from FDA and other national health authorities, the patient-information components of product labeling and/or associated Medication Guides are generally not tested for patient comprehension or readability and/or may not be generally useful for all patients. Ethnic and educational patient limitations can have important negative implications for clinical outcomes given that comprehension is not assured under current regulations or practices.

### BRIEF DESCRIPTION OF THE DRAWINGS

FIG. 1 illustrates a process in accordance with an embodiment of the invention;

FIG. 2 illustrates a process in accordance with an embodiment of the invention;

FIG. 3 illustrates a process in accordance with an embodiment of the invention;

FIG. 4 illustrates a system in accordance with an embodiment of the invention; and

FIGS. 5A-5C illustrate a process in accordance with an embodiment of the invention.

### DETAILED DESCRIPTION

Systems and methods in accordance with an embodiment of the invention may use literacy, language, and cultural normalization technologies to provide consumer-specific communications in support of treatment-optimization and risk-management for inherently dangerous consumer products—for example, drugs, medical devices and nutritional supplements. Because of the diversity of cultures within a general population, and the varying levels of literacy within and between these cultures, embodiments of the invention may provide information for appropriate product utilization in a manner consistent for successful consumer comprehension by the members of these diverse cultures and capabilities. One or more embodiments of the invention can implement a risk evaluation and mitigation strategy so as to educate consumers on the safe and proper use of dangerous products.

Implementations of the invention provide communications regarding safe and effective use of drugs, medical devices, nutritional supplements, etc. to individual patients despite cultural barriers, and obtain feedback from those with cultural barriers regarding treatment-results to help assure proper drug use in subsequent product users, overcoming the disadvantages of ethnicity hurdles and reduced literacy among the user population.

In accordance with an embodiment of the invention, literacy, language and cultural normalization technologies may provide consumer-individualized communications in support of treatment-optimization and risk management in a patient's native language and at a literacy level suitable to match the patient's abilities. Consumers, regardless of ethnicity and education, can be empowered with the ability to provide feedback on their actual product usage. Consumers can also communicate if they fully or only partially understand how these products (henceforth referred to as “drugs”), are properly used based on the information provided to them. Consumers can provide real-time feedback on their treatment outcomes. This consumer feedback may be aggregated in a dynamic consumer-feedback communications database.

A system in accordance with an embodiment of the invention may include a database containing information that can be mined for information used to provide assessments of the level of patient/consumer comprehension of appropriate product usage and/or assessments of the influence of counseling on outcomes. Feedback from patient/consumers can be used to improve comprehension and outcomes for future counseling efforts.

In one implementation, this database can be used to further refine the adequacy of consumer communications and thereby incrementally improve outcomes and product labeling. Data collection technologies in accordance with an embodiment of the invention may access consumers' product use behaviors to obtain information and patterns regarding drug compliance and label readability/comprehension. The obtained information and patterns can be applied to correct deficiencies and also to assess whether a product's label is adequately meeting its communication objective or needs improvement. In one implementation, recommendations for product label changes may be communicated to manufacturers and regulatory authorities.

A system in accordance with an embodiment of the invention may include a user-friendly, interactive interface that can communicate to a consumer how to optimize product effectiveness and safety. This consumer-communication interface adjusts to the specific language, literacy level, ethnicity and culture of the user to provide information focusing on the unique drug responses (e.g., black box warnings, essential information from product labeling such as Medication Guides, drug interactions, food effects and restrictions, behavioral risks, genetic predispositions, ethnic-specific risks and performance expectations) of the sub-population to which the user belongs. The consumer communication interface can receive feedback from the user on their individual comprehension of the product information provided by the system, and on their individualized outcome from product use or treatment. The feedback data from the user may be translated and, if needed, converted into common terminology. This data can be aggregated using statistical or empirical methods for optimization of subsequent culture-specific communications to consumers, and for updating of product labeling by manufacturers in collaboration with the FDA.

A computer or processor-based method in accordance with the invention provides an automated method for providing information on medications to a consumer in a culturally-normalized manner. The method may include the steps of receiving information from an individual identifying at least one medication, providing to that individual information that could be relevant to a user of each identified medication, presenting at least one question to the individual, each question being designed to ascertain that individual's understanding of the provided information, receiving responses from the individual for each presented question, and determining whether or not the received responses meet a prescribed criteria. If the determination is that the responses do not meet the prescribed criteria, the method may include re-educating the individual until a correct response is obtained, and/or directing the individual to a live person knowledgeable in the identified medication. This interaction with the individual may be done in a format, language, and literacy level targeted to the particular individual. The information provided to the individual along with the questions presented may be done in a culturally-normalized manner so as to make the information and questions more easily understood by the particular individual.

In accordance with an embodiment of the invention, a method embodying the invention may be implemented via a literacy, language, and cultural normalization system(s). This system may include a memory and a processor and/or controller, a set of executable instructions stored in the memory and executable on the processor and/or controller. When executed, the instructions cause the processor and/or controller to identify at least one valuable user action based on at least one correlation determined from user data supplied by a plurality of users. The instructions include a component that identifies and recommends the communications path depending on an individual's literacy, language, and cultural requirements.

In one embodiment in accordance with the invention, users supply feedback (e.g., drug usage data) to be analyzed in conjunction with data associated with a plurality of other users to provide useful feedback (information) that can be aggregated in a dynamically growing consumer-feedback communications database. Data can be analyzed (e.g., by being parsed and/or mined) alone or in conjunction with third party data to identify correlations amongst the data and associated users. A system implementing an embodiment of the invention can access this data, process it statistically, and present results to pharmaceutical companies, regulatory agencies and other stakeholders in a myriad of manners, for instance feedback on consumer actual product usage, demographics, literacy levels, language, and understanding of how to properly use a given drug, feedback on treatment outcomes, etc. This system may access the patient-specific information to generate individualized product-usage communication strategies based on patient ethnicity and language capabilities. Patient responses provided to an interactive interface can be analyzed by a response evaluation unit that produces content recommendations designed to address each consumer's language/ethnicity specific self-management needs based on feedback from historical consumer communications and outcomes.

In accordance with an embodiment of the invention, individual and collective client data analysis can be used to better understand an individual's and/or a populations' collective ability to comprehend proper drug usage directions. This analysis can also be used to study actual product usage through real-time feedback of an individual's treatment. This analysis and study can be achieved through discovery of relationships or patterns in data relating to past behavior of a given population. Such patterns can be utilized to improve and to further refine the adequacy of consumer communications, thereby incrementally improve outcomes and product labeling. The process can identify favorable and problematic (e.g., risky) patterns of communication. For example, in one implementation an assessment of a consumer's risk for misreading and/or inappropriately using the drug can be made. Population pattern analysis studying demographic information (e.g., age, gender, education, cultural and ethnic background, etc.) can serve to increase a consumer's product label comprehension and drug utilization by correlating a presentation to the users' own demographics. Correlating the presentation can increase the consumer's ability to engage in appropriate behaviors and positively affect outcomes, while mitigating the risk of improper use of the drug.

Data collection and analysis technologies can be applied to client user data provided by the client, and stored on their behalf by third parties (e.g., doctor offices, pharmacies, hospital, etc.) and/or generated and maintained by third parties. Analysis of this data can enable identification of opportunities for recommendations to increase positive user outcomes and/or improve quality of life, and to reduce legal liabilities.

In accordance with an embodiment of the invention, personal user data can be received, or otherwise acquired from a plurality of local and/or remote data repositories. Data analysis can then be applied to the personal user data across a plurality of users, for example, to identify patterns, relations and/or correlations amongst the data. Subsequently or concurrently, mining results, and/or useful information based thereon, can be provided to a user in accordance with either or both of a push and pull data distribution model. The data analysis results can be stored in data store servers interconnected by an electronic communication network.

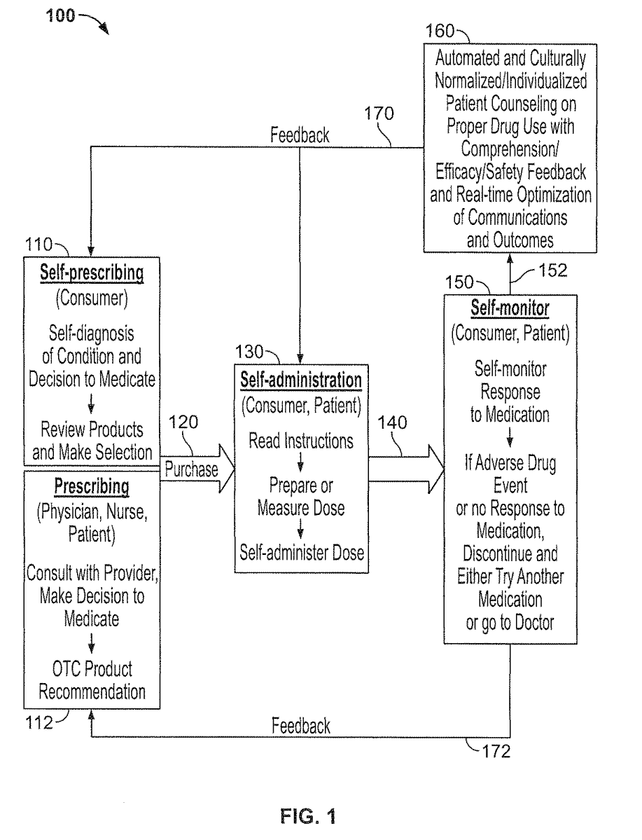

FIG. 1 illustrates, in accordance with an embodiment of the invention, medication-use process 100 for an over-the-counter (OTC) medication. A patient, acting as a retail consumer, may self-prescribe an OTC medication, step 110. The patient may self-diagnose their condition, make a decision to medicate themselves, and select an OTC medication by reviewing the product label. Alternatively, a medical provider may be consulted, step 112, for the diagnosis and OTC medication selection. In either event, the patient purchases the OTC medication, step 120, and self-administers the medication, step 130. The patient self-monitors their condition, step 150. If there is not any response to the medication, or if there is an adverse reaction to the medication, the patient may decide to seek a medical provider, step 172, or the patient may decide to self-prescribe another OTC medication, step 152. The patient may consult with a system that implements an embodiment of the invention, step 160. This system may provide automated, culturally-normalized, individualized counseling on the proper medication use of OTC products. After being advised by the system the patient may return to the OTC medication source, step 170, and perform self-prescribing step 112 with the benefit of the information provided by the system at step 160.

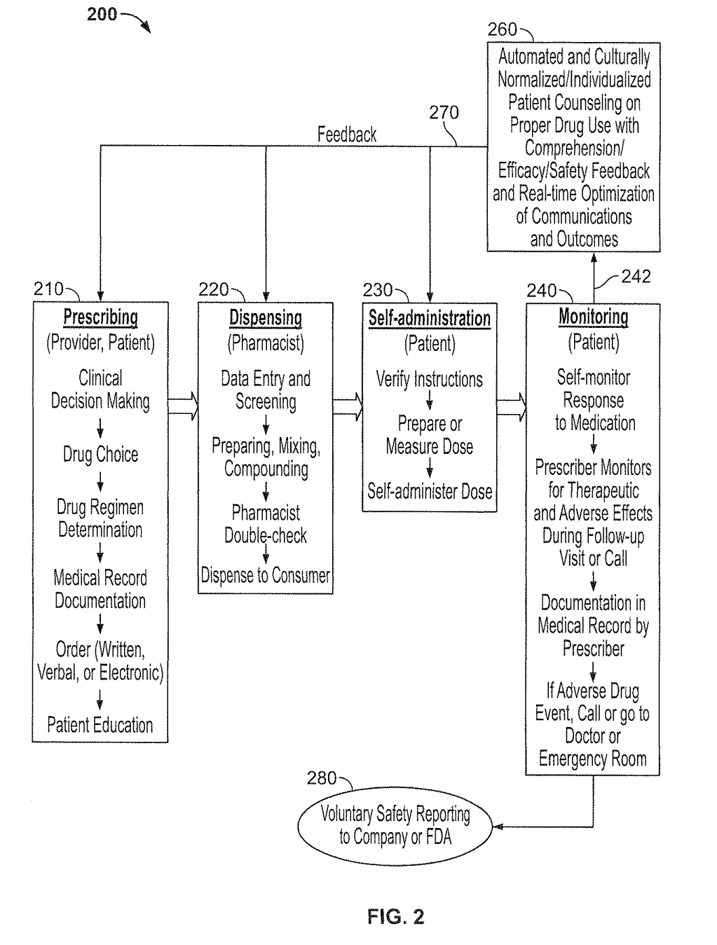

FIG. 2 illustrates, in accordance with an embodiment of the invention, medication-use process 200 for a community care facility. Prescribing step 210 involves both a medical practitioner/provider and the patient. A clinical decision is made by the practitioner after evaluating the patient's condition. This clinical decision informs the practitioner on drug choices, which lead to the drug regime determination. The decision and choice are documented in a medical record, an order is given (verbally, written, and/or electronically), and the patient receives drug usage education. Before the drug is dispensed to the patient, step 220, a pharmacist may prepare the compound. The prescription entry is double-checked and then provided to the patient. The patient self-administers the medication, step 230. The patient may also monitor their response to the medication, step 240. Additionally, the medical provider may monitor the patient's response to the medication, step 240, and document in the medical record. The patient may consult with a system that implements an embodiment of the invention, step 260. This system may provide automated, culturally-normalized, individualized counseling on the proper medication use. Patient responses obtained during the consultation may be used to improve each of the prescribing, dispensing, and self-administering phases of process 200 (respectively steps 210, 220, 230). In the event of an adverse reaction the patient may be sent to an emergency facility, and the community care facility may voluntary report, step 280, the adverse reaction.

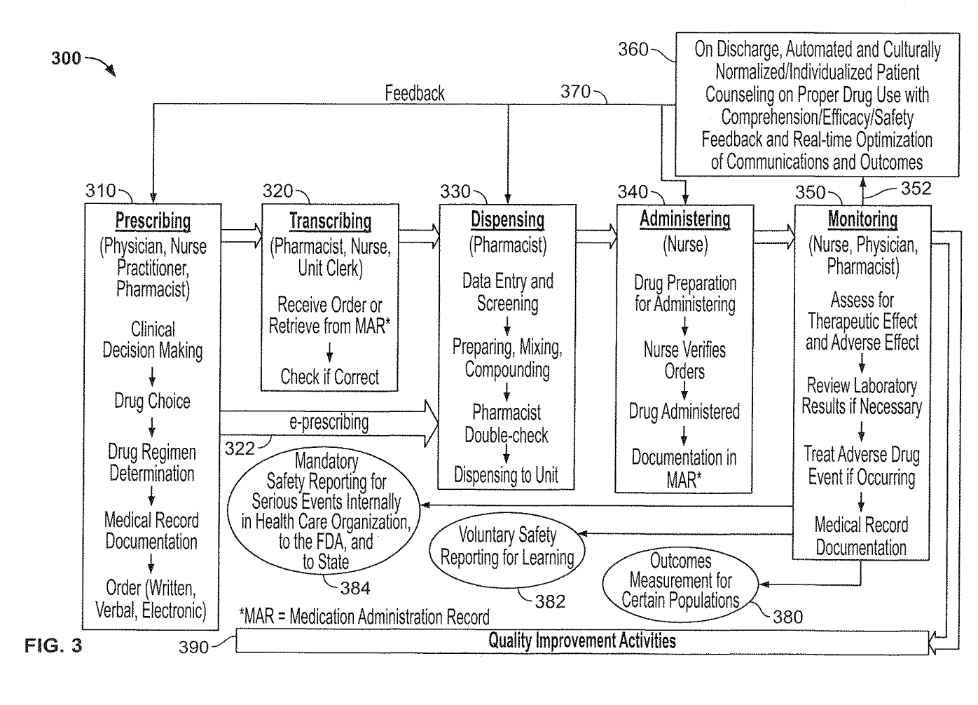

FIG. 3 illustrates, in accordance with an embodiment of the invention, medication-use process 300 for a hospital and/or long term care facility. Similar to process 200, process 300 includes a prescribing step (step 310) and a dispensing step (step 330). In addition, process 300 may include a transcribing step, step 320, where the order from a medical provider is checked for correctness by a pharmacist, nurse, or unit clerk. Process 300 may also include providing the medication order electronically, step 322. After dispensing, the medication is administered to the patient by a nurse (or other professional caregiver), step 340. Monitoring of the medication's effect on the patient is done by a medical provider while in the hospital or long term care facility, step 350. The facility can collect outcome data for certain populations, step 380, and/or voluntarily report incidents, step 382, to improve the knowledge base for the medication. There also may mandatory reporting obligations, step 384, for serious events. Further, the facility itself may have internal quality improvement activities, step 390. After discharge the patient may consult, step 352, with a system in accordance with an embodiment of the invention. This system may provide automated, culturally-normalized, individualized counseling on the proper medication use, step 360. Patient responses obtained during the consultation may be used to improve each of the prescribing, dispensing, and administering phases of process 300 (respectively steps 310, 320, 340).

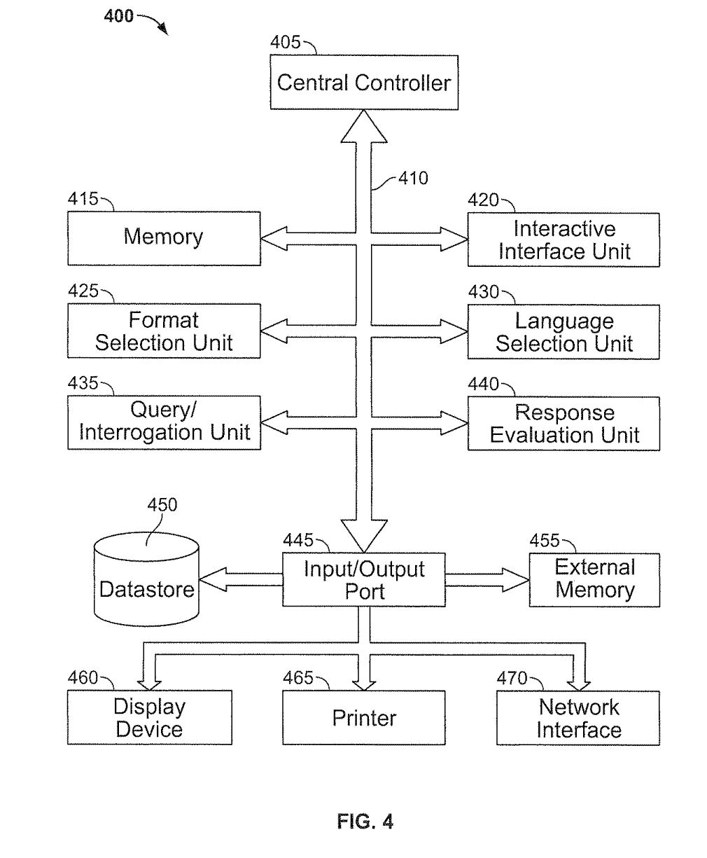

FIG. 4 illustrates system 400 for presenting a patient with drug information in a literacy, language, and culturally normalized manner in accordance with an embodiment of the invention. System 400 may include central control processor 405 that may be connected to an internal bus 410. The controller may be a processing unit, a field programmable gate array, discrete analog circuitry, digital circuitry, an application specific integrated circuit, a digital signal processor, a reduced instruction set computer processor, an AVR processor, etc. System 400 may include internal memory 415, which for convenience represents both volatile and non-volatile memory devices. Control processor 405 may access a computer application program stored in non-volatile internal memory, or stored in external memory 455. External memory 455 may be connected to control processor 405 via input/output (I/O) port 445. When executed, the computer application program may cause control processor 405 to perform one or more methods in accordance with an embodiment of the invention, as described below.

System 400 may be implemented in a network-connectable resource (e.g., personal computers, thin clients, terminals, workstations, mainframe computers, tablet computers, smart phones, personal digital assistants (PDA), hand-held computing devices, etc.). In one implementation, the network-connectable resource may be a kiosk accessible to a user in a variety of public and/or private locations (e.g., retail stores, shopping malls, pharmacies, medical practices, etc.). Network interface 470 can connect the system to an electronic communication network (e.g., Internet, intranet, local area network (LAN), wide area network (WAN), metropolitan area network (MAN), virtual private network (VPN), data center, data repository, cloud, optical wireless networks, high capacity wireless networks, etc.). In accordance with an embodiment of the invention, portions of system 400 may be distributed among client side and server side devices in communication across the electronic communication network. Various components of system 400, described herein, may be implemented in hardware, software, or a combination of hardware and software.

System 400 may include interactive interface unit 420. Interactive interface unit is configured to present an interactive interface to a user of system 400. The interactive interface may be, for example, a graphical user interface. The interactive interface unit may execute program instructions running on an application layer of the network-connectable resource, which when executed cause the interactive interface to operate on a presentation layer of the network-connectable resource. System 400 may include display 460, which may be a touch screen or movement-activated display, on which the interactive interface may be displayed. The interactive interface may collect information from a user of system 400, and may also provide information to the user. The information may include drug side effects experienced by that patient, and content regarding the patient's understanding of the dosage instructions and usage warnings for the drug. The user may also identify a desired language for the output provided. The user may also select the format of the provided content.

System 400 may also include format selection unit 425 that is configured to format output provided to a user in the format selected by the user. The format choice may include, but are not limited to, video, text (printed or displayed), audio, avatar (a virtual representation in a virtual environment), etc. For example, the format selection unit can implement a text to speech application which, in conjunction with an animated avatar displayed on display 460, provides audible output to the user in a language selected by the user.

In response to the user's selection of a language, language selection unit 430 is configured to access content to be provided to the user in the selected language. Data store 450 may contain a database of drug precaution information in many languages. Language selection unit 430 may access the multiple language content by indexing into the database's records, where the index represents a particular language selected by the user. In another implementation, language selection unit 430 can be configured to translate content (e.g., input from a user, and/or output provided to the user) in a near real-time condition as the content is received. Language selection unit 430 may also be configured to access language content at a particular literacy level for a particular user. This literacy level may be selected by evaluation of responses to certain queries posed by system 400 to the user. Regardless of content, the output presented by the system is designed to be in plain language (e.g., layman terms as opposed to medical jargon and technical terms) so as to be understandable to a person with a minimal amount of formal education—for example, about an eighth grade reading level or below.

Query/interrogation unit 435 is configured to provide interactive interface unit 420 with questions to be presented to the user. The questions may be presented in the same output form previously selected (e.g., video, text, audio, avatar, etc.). The questions are designed to determine whether the user understands the plain language output information provided by system 400. Questions may be presented in multiple choice format. The user may select their response by activating a radio button or checkbox on the graphical user interface.

Response evaluation unit 440 is configured to analyze the response obtained from the user to evaluate the depth of understanding that the user has of the information provided in the plain language output. Response evaluation unit 440 can evaluates the user's responses by comparing the responses to predetermined criteria. The comparison can evaluate the accuracy and depth of the user's understanding of the plain language output. For example, for many “black box” label drugs communication of the risks and appropriate product usage to protect the individuals from morbidity and mortality, and to mitigate risk in the patient population, may be documented. Criteria for comprehension can be created based on the need for risk mitigation and enhanced potential for product effectiveness.

Responses from the user can be stored in a dynamic consumer-feedback communications database, which may be located in data store 450. These accumulated responses can be analyzed with respect to a myriad of different patient attributes and demographics.

By applying heuristic algorithms to the data within the dynamic consumer-feedback communications database, system 400 is able to deliver an appropriate level of individualized interaction for each user. Response evaluation unit 440 is configured to access the aggregated information in the database and synthesize and monitor interaction with structured and unstructured data and learning preferences, which can be displayed and stored in a client specific storage site (e.g., an external memory and/or a location within data store 465). By parsing the aggregated information, response evaluation unit 440 explores, analyzes, trends and correlates data to deliver better/improved health, drug outcomes.

System 400 can implement real-time use of data on a unified data platform to improve patient outcomes, improve patient/client experience, support prescription and OTC product distribution. The data may include use/warnings for non-medical items (e.g., retail store items), infant medications, customized infant medications, consumer-specific communications, supports low literacy levels, supports a variety of languages, supports cultural localizations—for example, a cultural-based tendency to inadequately engage with the health care system, tendencies to not recognize disease states and the need for adherence to or compliance with treatments, and genetic/cultural predispositions to diseases and product safety/efficacy, supports educational level, supports best health outcomes for individuals, population subsets, and the community.

The data center service can provide functionality for personal data mining and data repository; it provides a mechanism for identifying or uncovering implicit, previously unknown, and potentially useful information from the data stored in the dynamic consumer-feedback communications database. Response evaluation unit 440 can parse patterns and/or correlations amongst user data and/or users themselves. A data mining component of response evaluation unit 440 can employ a single or combination of analysis techniques including, without limitation, parametric and non-parametric statistics, frequentist inference statistical models, Bayesian statistical models, non-linear mixed effect models, linear and non-linear regression analyses, decision trees, clusters, rule induction, nearest neighbor model. The techniques can be employed to identify patterns and/or correlations.

The dynamic consumer-feedback communications database, in accordance with an embodiment of the invention, can be operable to store personal user data associated with a plurality of users and to render all specific consumer identifications as undiscoverable (i.e., anonymize the data). This anonymized data is appropriate for compliance with requirements of the Health Insurance Portability and Accountability Act (HIPAA) and other federal and state regulations. Data can include but is not limited to personal management information (HIPAA data), text, pictures, videos, documents, e-mail, instant messages, addresses, calendar dates/scheduling information (e.g., birthdays, anniversaries, appointments, etc.), voice mail, literacy level scores, language assessments, cultural assessments, prescriptions, product label and usage education and comprehension responses, clinical outcome data.

The response evaluation unit analysis can indicate a correlation between users who prefer one product and users who prefer another product; such data can be interpreted to provide a suggestion to a user to try the other product based on the correlation. Data can provide useful information from personal user data associated with more than one user, for instance, at least a subset of the received or retrieved personal user data associated with a plurality of users can be analyzed to identify patterns, correlations or other previously unknown information. In general, such data mining can be used to achieve composite ethnic group medical knowledge of effects where data can be aggregated amongst many users to identify trends and patterns and the like. Data can assume many formats including text, sound, graphics and video.

The results can be provided in accordance with either a push (e.g., notification, reminders) or pull (e.g., active search) model. The results can be utilized by medical professionals, regulatory agencies and manufacturers to better understand the needs of population sub-sets and individuals. Data from population subsets can be used to enhance statistical (such as by using frequentist inference or Bayesian models) and empirical significance to improve quality of treatment of individual consumers. Data from individual consumers can be combined with data from population subsets sharing similarities to that consumer to enhance probability statements about appropriate interactions and communications with that individual consumer to improve comprehension of essential medical information, and the quality/cost-effectiveness of medical treatments/outcomes.

In accordance with an embodiment of the invention, response evaluation unit 440 may interact with query/interrogation unit 435 in conjunction with interactive interface unit 420. In this implementation, if a user answers a question incorrectly, s(he) will then be reeducated. Following re-education, the user can then be asked to answer the previous, incorrectly answered test questions again. This process can be repeated until correct answers are obtained, or an alternative education process is used.

Control processor 405 may provide printer 465 with data to print information to be provided to a patient or user. The information may be stored in data store 450 accessible by control processor 405 and/or printer 465.

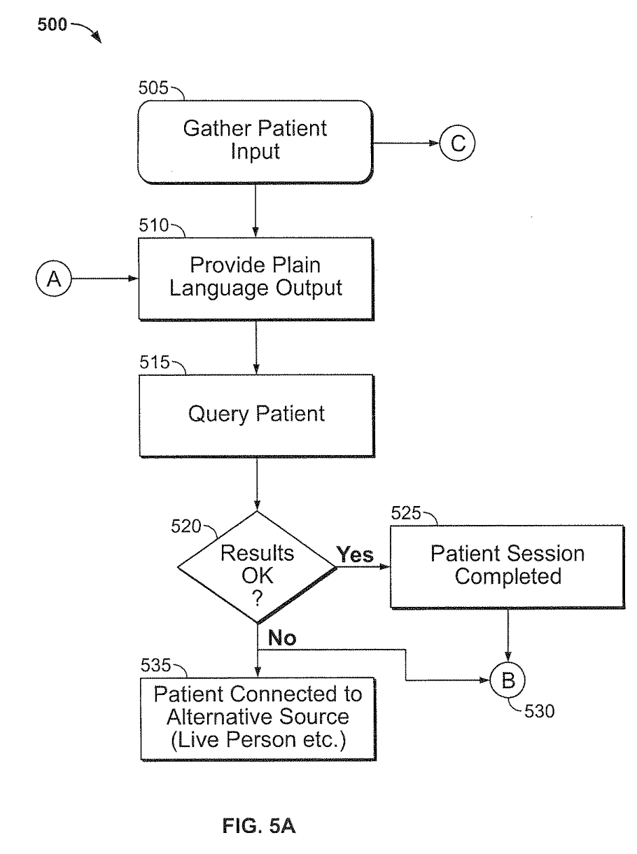

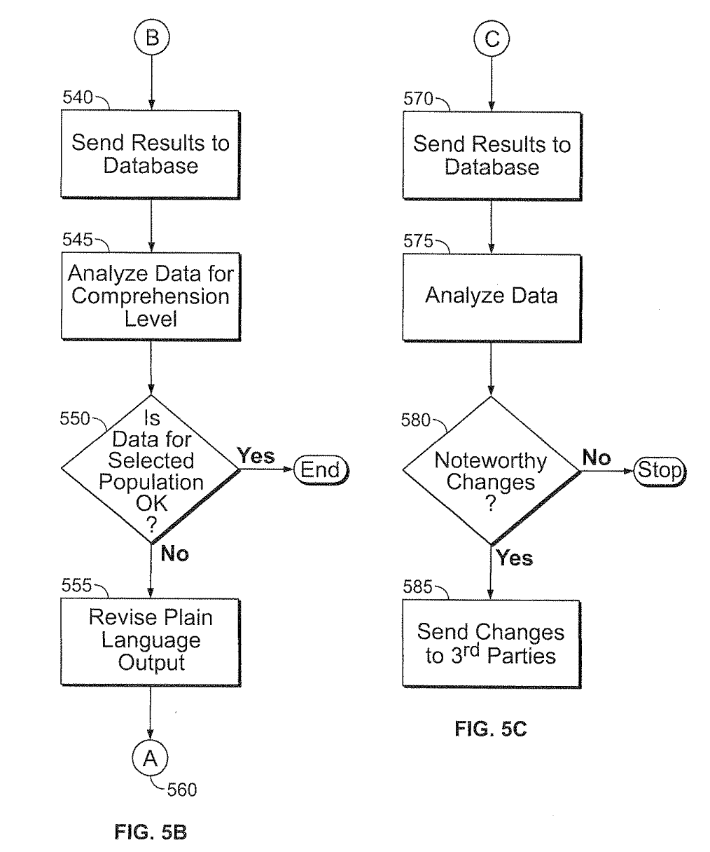

FIGS. 5A-5C illustrate process 500 for providing a patient, and/or caretaker, with drug information in accordance with an embodiment of the invention. At step 505, process 500 obtains information about the patient. This information may be obtained by retrieving electronic records from a database of a service provider (e.g., doctor, pharmacist, hospital, clinic, nurse, nurse practitioner, dentist, veterinarian, etc.). The patient information may also be entered by the patient via an input/output interface (keyboard, pointer device, touch screen display, interactive graphical user interface display, motion-activated technology (e.g., MICROSOFT SURFACE®, Microsoft Corp., Redmond, Wash.), etc.) connected to a system implementing the method.

Collected information may include drug side effects or effectiveness measures experienced by that patient, and content regarding the patient's understanding of the dosage instructions and usage warnings for the drug. Information gathered during step 505 may also include input from the patient identifying a patient-desired language for the output provided, and further allows the patient, or a patient's representative, to select the form of the plain language output provided to the patient. The plain language output may be in a format selectable by the patient, or a patient's representative, including, but not limited to, video, text (printed or displayed), audio, avatar (a virtual representation in a virtual environment), etc.

At step 510 the plain language output is provided in the patient-desired language and format identified during step 505. The output information can include details on the drug being prescribed and/or purchased over the counter. The details on the drug may include information found in a consumer medical information package insert or patient information brochure. These details may include: warnings, conditions for appropriate use, drug side effects, drug and food interactions, contraindications, proper storage and use, dosing instructions and frequency, optimum time of day, whether the drug is to be taken with or without food, liquids, and the like, methods to assess drug effectiveness and safety, expected outcomes, alternative and concomitant treatment options, plus answers to commonly asked patient questions regarding the drug.

In accordance with an embodiment of the invention, process 500 may ascertain the patient's understanding of the plain language output. At step 515, the patient is questioned in the same output form as selected during step 505 (e.g., video, text, audio, avatar, etc.) to determine whether the patient understands the plain language output information provided in step 510. These questions may be on one or more of the drug's details presented in the plain language output of step 510.

The questions of step 515 may be presented in multiple choice format. For example, the patient may be asked to choose (for example, by selection of a radio button or checkbox on a graphical user interface (GUI)) which statement regarding the drug is true—“This is the safest medicine.” versus “This medicine may have serious side effects.” The query may also present a series of statements about the drug and request that the patient check all statements that may apply. Questions may also be designed to elicit the patient's knowledge regarding proper dosage, usage (for inhalers, needle pens, and the like), handling/storage, drug/food interactions, etc.

The patient's responses to the queries are examined, step 520, by an evaluation unit. If the patient's responses meet predetermined criteria that evaluates the accuracy and depth of the patient's understanding of the plain language output—for example, by documenting comprehension of “black box” label warnings, and/or the patient's understanding of essential risk-to-benefit relationships for the treatment, process 500 completes the patient interactive session, step 525, and provides the patients' responses from step 515 to the dynamic consumer-feedback communications database, step 530.

If the patient responses do not meet the predetermined criteria, the patient's responses are provided to the dynamic consumer-feedback communications database, step 530, and process 500 continues to step 535. At step 535, the patient can be connected to an alternative source of information to provide details to the patient regarding drug usage. This alternative source of information may be a live person or an alternative automated interactive system at a lower level of literacy requirement, or an alternative language/dialect subset that can communicate with the patient, and/or caretaker, via the output mode selected at step 505 (e.g., video, text, audio, avatar, etc.). In one implementation in accordance with an embodiment of the invention, process 500 may return to step 510 to provide updated plain language output to the patient, after the plain language output is updated with the results provided to the dynamic consumer-feedback communications database at step 530.

With reference to FIG. 5B process 500 may collect feedback on the quality of the plain language output by evaluating the patient's responses, whether the predetermined criteria of step 520 is net or not. At step 540, the patient's responses are sent to the dynamic consumer-feedback communications database. At step 545, this body of data is analyzed to determine whether it is understandable to patients belonging to a particular patient population. The time period between such analyses can be done at predetermined intervals (uniform or non-uniform), or on demand, or be continuously updated. Patient comprehension of the plain language output provided at step 510 (FIG. 5A), can be analyzed with respect to all patients to whom the response is provided, and/or can be analyzed according to patient age, ethnicity, language, geographical area, etc. Regardless of how the patient population is defined, at step 550, the results for a given patient population are compared to a predetermined comprehension threshold. If the comprehension threshold is not met, then at step 555, the plain language output is revised and updated. This revised, updated plain language output is provided to the communication interface, step 560. The updated plain language output is then available for future patients for a given patient population, or can be used in an ongoing session with a patient having unsatisfactory responses—i.e., a patient connected to an alternative source of information at step 535 can be returned to step 510.

With reference to FIG. 5C, and in accordance with an embodiment of the invention, the information gathered during step 505 may be sent, step 570, to the dynamic consumer-feedback communications database. As a use for the dynamic consumer-feedback communications database, the data can be mined to determine if a consumer/patient understands the indication, the relationship between risk and benefit, the dose and dosing intervals, contraindications, warnings and drug/food interactions, and when to stop and start using the drug.

Based on such assessments, additional education/counseling can be provided through an iterative comprehension evaluation (e.g., by repeating steps 510-520) until responses indicate that the patient adequately understands how to engage in appropriate product-usage behaviors. The database can be refined to better target educational content for subsequent patients from the same, or similar, demographic sub-population as the present patient. In so doing, the educational information provided in the plain language output of step 510 and confirmatory questions of step 515 can be clarified to improve outcomes. Also, medical and other outcome information can be solicited subsequently to characterize the medical or other impact of the educational/counseling process on health outcomes and well being.

As described above, a patient's response to queries regarding their understanding of drug effectiveness expectations or side effects or other issues, such as co-morbidities, can be stored in the dynamic consumer-feedback communications database. These accumulated responses can be analyzed with respect to a myriad of different patient attributes and demographics. For example, side effects experienced by Hispanic males between the ages of 20 and 30 who may also be taking drug “XYZ” can be identified.

This parsing of effectiveness measures, co-morbidities, and side effects with respect to patient attributes as described provides a wealth of potentially valuable data to drug companies, independent drug researchers, government regulators, and health care payers/providers. As illustrated in FIG. 5C, data gathered at step 505 about the patient's past experiences with the drug, etc. are provided to the dynamic consumer-feedback communications database, step 570. At step 575, this data can be analyzed, collated, and reduced/summarized. The reduced/summarized data can be reviewed, step 580, to discern noteworthy changes with respect to an existing knowledge base for the drug. The reduced/summarized data can provide a sentinel signal suggesting a need to collect additional specific data, or, if statistically robust, a definitive assessment for purposes of characterizing product efficacy and safety in labeling. For example, it may be noteworthy to find that one ethnic group in particular has a higher incidence of treatment failure and/or adverse events when using an antihypertensive medication despite documented, adequate comprehension of risks and benefits. This noteworthy finding may be communicated to the medication's manufacturer and regulators, which may decide to add this information to product labeling. If no noteworthy changes are discerned, process 500 ends.

If there are noteworthy changes, such results can be sent to third parties, step 585. Such third parties may include, for example, pharmaceutical companies, drug researchers (independent, corporate, or academic), pharmacists, doctors and other health care professionals, payers, managed care organizations, regulators, and medical journals.

A method in accordance with an embodiment of the invention, individual patients are queried on their comprehension of the plain language output presented to the patients by system 400. The patient answers to these questions can be stored in the dynamic consumer-feedback communications database, where analysis of the patient's comprehension can be assessed by various subgroups (e.g., ethnicity, age, gender, literacy level, disease, etc.). Changes to the questions and communication methods can be made over time to improve the ability to provide the plain language output in a manner that can lead to adequate comprehension of the essential communications. These changes may involve changing the literacy level of the language, but it could also involve changing the language or venue of the communication method, and/or the number, format or language of the questions asked. In one implementation, the literacy level may remain unchanged because in this implementation the literacy level is at a level understandable by a large swath of the population (e.g., sixth grade or below). The method can include updating the database with patient comprehension and outcomes data combined with individual patient data to improve the system communication capabilities, and to serve as a sentinel alert system for product use and labeling changes.

In accordance with an embodiment of the invention, a computer program application stored in non-volatile memory or computer-readable medium (e.g., register memory, processor cache, RAM, ROM, hard drive, flash memory, CD ROM, magnetic media, etc.) may include code or executable instructions that when executed may instruct or cause a controller or processor to perform methods discussed herein such as a method, for presenting a patient with drug information in a literacy, language, and culturally normalized manner in accordance with an embodiment of the invention.

The computer-readable medium may be a non-transitory computer-readable media including all forms and types of memory and all computer-readable media except for a transitory, propagating signal. In one implementation, the non-volatile memory or computer-readable medium may be external memory 455 (FIG. 4).

In accordance with an embodiment of the invention, system 400 and process 600 can provide safe and effective guidance on the use of medical therapeutics, and for continuously testing and improving delivery of proper communications. The targeted communications can provide datasets that aggregate valuable drug-information comprehension, safety, efficacy, demographic and marketing information for new and established products/indications. This information can be provided to drug companies, manufacturers, payers, health maintenance organizations, managed care organizations, and regulatory authorities to support desirable health care outcomes, regulatory submissions, marketing objectives and advertising substantiation. Data on category dynamics can also be generated from the database and published.

An embodiment in accordance with the invention can provide a comprehension-enhancing technological solution that continuously improves individual-patient and population comprehension and outcomes. For example, patient outcomes can be improved within the context of the routine delivery of healthcare via comprehension-enhanced communication of the “black-box” label warnings found in patient brochures, Medication Guides, and/or other communication vehicles mandated by regulators. These documents are also used as a tool to enhance patient care in the practices of physicians, nurse-practitioners, or other licensed healthcare practitioners in their offices. This technology may be used to meet regulatory requirements for documentable risk-mitigation strategies by pharmaceutical and medical device companies, and for delivery of Medication Therapy Management services by pharmacists. The system can also be used to mitigate legal liability risks by documenting required communications and/or patient/caretaker comprehension.

A system and method in accordance with an embodiment of the invention can be used to provide diligent and documented communications of risk-to-benefit relationships as a condition to place patients on drug registries. These drug registries are used to screen patients to assure that they are appropriate candidates for treatment with “black box” or high risk drugs, and only patients allowed into the official registry can receive these high risk drugs.

While there have been shown and described fundamental novel features of the invention as applied to one or more embodiments, it will be understood that various omissions, substitutions, and changes in the form, detail, and operation of these embodiments may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A method for providing consumer-specific communication based on cultural normalization techniques, the method comprising:
obtaining information about the consumer using an interactive interface running on an application layer of a network-connectable resource;
receiving an identification of a consumer-selected language and an output format selection;
providing plain-language output information in the consumer-selected language and output format;
presenting questions, by a query/interrogation unit, regarding the plain-language output information;
acquiring responses to the presented questions; and
ascertaining an understanding of the plain-language output information based on the acquired responses.

2. The method of claim 1, the obtaining step further including retrieving electronic records from a service provider database.

3. The method of claim 1, the obtained information including at least one of product usage experienced by the consumer and an indication of the consumer's understanding of product label instructions and warnings.

4. The method of claim 1, wherein the output format selection is at least one of video, text, audio, and avatar.

5. The method of claim 1, the ascertaining step including comparing the acquired responses to predetermined criteria by a response evaluation unit.

6. The method of claim 5, including connecting the consumer to an alternative source of information if the comparing step results are below the predetermined criteria.

7. The method of claim 5, wherein if the comparing step results are below the predetermined criteria, the method further including the steps of:
updating the plain-language output information based on the comparing step results;
providing the updated plain-language output information in the consumer-selected language and output format;
presenting questions regarding the updated plain-language output information;
acquiring responses to the presented questions; and
ascertaining an understanding of the plain-language output information based on the acquired responses.

8. The method of claim 7, further including repeating the updating, providing, presenting, acquiring, and ascertaining steps until the ascertaining step result indicates that the acquired responses meet the predetermined criteria.

9. The method of claim 1, including the step of providing the acquired responses to a dynamic consumer-feedback communications database.

10. The method of claim 9, including mining contents of the dynamic consumer-feedback communications database to determine if the consumer has an understanding of a product usage and warning instructions.

11. The method of claim 9, including analyzing contents of the dynamic consumer-feedback communications database with respect to consumer attributes and demographics.

12. The method of claim 11, including providing a sentinel signal based on the analysis, wherein the sentinel signal indicates at least one of a need to collect additional specific data, and a need to perform a definitive assessment to characterize product efficacy and safety in labeling.

13. The method of claim 11, wherein the sentinel signal is provided to at least one of a pharmaceutical company, a drug researcher, a pharmacist, a health care professional, a medical payer, a managed care organization, regulators, and a medical journal.

14. The method of claim 9, including parsing contents of the dynamic consumer-feedback communications database for information regarding side effects experienced by consumers of a particular product.

15. The method of claim 1, including the steps of:
determining a literacy level of the consumer based on the obtained information by parsing the obtained information;
and providing plain-language output information at the determined literacy level.

16. A non-transitory computer readable medium having stored thereon instructions which when executed by a processor cause the processor to perform the method of:
obtaining information about the consumer using an interactive interface running on an application layer of a network-connectable resource;
receiving an identification of a consumer-selected language and an output format selection;
providing plain-language output information in the consumer-selected language and output format;
presenting questions, by a query/interrogation unit, regarding the plain-language output information;
acquiring responses to the presented questions; and
ascertaining an understanding of the plain-language output information based on the acquired responses.

17. The non-transitory computer readable medium of claim 16, further including instructions for:
comparing the acquired responses to predetermined criteria by a response evaluation unit; and
connecting the consumer to an alternative source of information if the comparing step results are below the predetermined criteria.

18. The non-transitory computer readable medium of claim 17, wherein if the comparing step results are below the predetermined criteria, further including instructions for:
updating the plain-language output information based on the comparing step results;
providing the updated plain-language output information in the consumer-selected language and output format;
presenting questions regarding the updated plain-language output information;
acquiring responses to the presented questions;
ascertaining an understanding of the plain-language output information based on the acquired responses; and
repeating the updating, providing, presenting, acquiring, and ascertaining steps until the ascertaining step result indicates an understanding by the consumer based on satisfying the predetermined criteria.

19. The non-transitory computer readable medium of claim 16, further including instructions for:
providing the acquired responses to a dynamic consumer-feedback communications database;
mining contents of the dynamic consumer-feedback communications database to determine if the consumer has an understanding of a product usage and warning instructions;
analyzing contents of the dynamic consumer-feedback communications database with respect to consumer attributes and demographics;
parsing contents of the dynamic consumer-feedback communications database for information regarding side effects experienced by consumers of a particular product; and
providing a sentinel signal based on the results of at least one of the mining step, analyzing step, and parsing step, wherein the sentinel signal indicates at least one of a need to collect additional specific data, and a need to perform a definitive assessment to characterize product efficacy and safety in labeling.

20. A system for providing consumer-specific communication based on cultural normalization techniques, the system comprising:
a central controller in communication with an internal bus;
an interactive interface unit, controlled at least in part by the central controller, configured to present an interactive interface to a user, to collect information from the user, and to present information to the user;
a format selection unit configured to format plain language information provided to the user in the format selected by the user through the interactive interface unit;
a language selection unit configured to access content in a database, the content to be provided to the user in a language selected by the user through the interactive interface unit;
a query/interrogation unit configured to provide the interactive interface unit with questions to be presented to the user; and
a response evaluation unit configured to analyze responses to the questions and to determine a user's literacy level.

21. The system of claim 20, wherein the plain-language output information is provided at the determined literacy level in the consumer-selected language and output format

22. The system of claim 20, wherein the language selection unit configured to access the content at a literacy level based on results provided by the response evaluation unit.

23. The system of claim 20, the response evaluation unit configured to compare the responses to a predetermined criteria to ascertain a user's comprehension of the plain language output information.
